(19) United States
(12) Patent Application Publication
(10) Pub. No.: US 2010/0227028 A1
(43) Pub. Date: Sep. 9, 2010

(54) METHOD FOR THE PREPARATION OF A DRY INSTANT FOOD COMPRISING AT LEAST TWO COMPONENTS, AS WELL AS DRY INSTANT FOOD PREPARED BY THE METHOD

(75) Inventor: Kaja M. Huitfeldt Nove, Hell (NO)

Correspondence Address: DENNISON, SCHULTZ & MACDONALD, 1727 KING STREET, SUITE 105, ALEXANDRIA, VA, 22314, US

(73) Assignee: KAJSALILLA AS, Stjordal (NO)

(21) Appl. No.: 12/280,178

(22) PCT Filed: Feb. 26, 2007
(86) PCT No.: PCT/NO2007/000073

§ 371 Date: Sep. 22, 2008

(30) Foreign Application Priority Data
Feb. 27, 2006 (NO) 20060962

(51) Int. Cl. A23L 1/31; A23L 1/48; A23L 1/212; A23L 1/325

(52) U.S. Cl. 426/129; 426/393; 426/106

(57) ABSTRACT

Method for the preparation of dry instant food comprising two or more components, comprising the following steps:—the individual components are prepared to a ready-to-eat meal by at least one per se known preparation process water and heating as well as mixing of the components,—the resulting mixture is subjected to a drying process comprising:—freezing the mixture,: drying of the mixture to a moisture content less than 15% in at least one drying step with a temperature lower than 0° C.,—packing of the dried product in a foil package. The invention also provides the product manufactured by said method.

According to a first aspect the present invention concerns a method for preparation of a dry instant food comprising two or more components which rapidly is rehydrated upon addition of warm or tempered liquid and thereby ready be served in a few seconds.

According to a second aspect the present invention provides a dry meal prepared by the method according to the first aspect of the invention.

### BACKGROUND

There is generally a demand for food which is easy to prepare and which still offers a complete and adequate meal with a mixture of components that together cover a diversity of the body's need of vitamins and minerals. It is thus desirable that such rapidly preparable meals shall contain a combination of foodstuff which comprises components of meat, fish, vegetable and fruit in some combination.

It is furthermore a requirement that foodstuff have a long shelf life preferably even when cool storage, like in a refrigerator, for some reason is not possible. It is furthermore a requirement that foodstuff can be prepared substantially free of bacteria which is the main cause of premature deterioration of foodstuff.

An additional need or desire is to be able to use packages which are not easily damaged and which do not increase the weight and thereby the freight costs more than necessary.

The above mentioned needs can be said to be of a general or universal character. Within some areas of application they are however more pronounced than within others. An example of such an area of application is distribution of foodstuff to areas which have experienced natural disasters and where no refrigerators or cold-storage chambers are available, requiring rapid transport and distribution of large amounts of foodstuff while the temperature and temperature variations can be extreme and where the environment may be characterized by significant pollution and possibly flooding and where a gentle handling of the goods is difficult to achieve in all elements of the transportation.

Another area of application is foodstuff for children, especially small children, for which it is desirable to compose adequate and nutrient-rich meals in one and the same package, i.a. to allow as little time as possible for the preparation and still be guaranteed coverage of a broad range of nutrients. It is important particularly in connection with travel or leisure use that the packages and the foodstuff do not require too much space and do not have an excessive weight, but still are well protected from damage caused by temperature variations.

In the area of infant food there is a broad spectre of fully prepared meals on glass jars. These represent a good offer in the sense that they provide complete meals which are easily prepared to a ready-to-eat meal with a simple warm-up. The disadvantage of this type of products is that the package is easily damaged and adds a lot of weight to the foodstuff. Foodstuff packed in this manner is not well suited as during travels and completely unsuited for use during natural disasters and more generally in parts of the world in which storage in cold storage chambers or refrigerators is not possible at all times.

It is known in the art that freeze drying may be a convenient technique of preparing some components for foodstuff in order to obtain long shelf life and low weight while substantially preserving the nutrients therein. It is furthermore well known that the last part of the drying may be conducted at a higher temperature to simplify the process and make it less expensive without damaging the product. It is however not known to use freeze drying to preserve prepared heterogeneous foodstuff that constitute complete ready-to-eat meals.

In WO publication No. 89 08229 (Stroemmen et al) is described a method for drying and/or freezing a granular material, particularly organic materials. The material to be dried is fluidized by means of a drying medium that flows through the granular material from below. The drying medium circulates in a closed loop comprising a drying chamber and a heat pump comprising means to heat the drying medium if required.

### OBJECTS

It is an object of the present invention to provide a method for the preparation of ready-to-serve meals in a manner that allows long shelf life when stored at ambient temperatures, low weight and environmentally friendly and strong package.

It is a particular object to provide a method for the preparation of ready-to-serve dinner portions of infant food with all nutrients preserved, which may be prepared for eating very quickly and which fulfil all requirements mentioned in the paragraph above.

It is furthermore an object to provide a method for the preparation of foodstuff in the form of complete meals with a broad spectre of nutrients which are well suited for distribution and use during natural disasters and in situation where the foodstuff is not likely to be handled carefully or kept cool.

### The Invention

The said objects are achieved by the present invention which is defined by claim 1.

According to a further aspect the present invention concerns dry instant food as prepared by the method according to the first aspect if the invention, as defined by claim 19 (should be 22). It is characteristic feature of the products according to the second aspect of the invention that they are “instant” products, i.e. ready to be served very quickly upon addition of warm or tempered liquid.

Preferred embodiments of the invention are disclosed by the dependent claims.

The preparation process is generally a process comprising at least a heat treatment with water present, typically boiling of one, more, or all of the components included in the final product. It is evident that not all components need a heat treatment or boiling of the same duration. Parts of this process can therefore be performed individually for each component while there will typically be a subsequent phase of preparation in which several or all of the components have been combined. It is a central element of the present invention that several components or components are combined to a heterogeneous mixture before the drying process is conducted. Thereby is obtained an “instant” product in which the original combination of taste substances, flavours and combinations of same are present at the subsequent rehydration which would not be the case if the components were handled separately.

With “components” as used herein is understood nutritive substances which typically include meat, fish, bird, vegetable, root vegetable and fruit. Flavouring compounds like spice, and salt as well as water and flour does not, however, constitute components of a meal in this meaning of the word.

By means of the heating and optionally boiling is ensured that any bacterial flora in the components is knocked out, while the primary object of the process is to make the meal ready to serve by allowing the components to absorb water and become more soft and tender and more easily digestible than in the raw, untreated condition. In addition flavours are released and mixed with other flavours. The preparation can also include further steps with the aim of sterilizing the raw materials or the final product but this is not a characteristic feature of the present invention.

A product in the form of a complete, ready, adequate meal is obtained by the process according to the present invention. It has a low water content and all nutrients are preserved; it is packed in a package which is lightweight and strong and the combination of the product's and the package's form ensure a very good shelf life even when stored at ambient temperatures and possibly in a moist environment. While it is obvious that the package should have a moisture barrier it is preferred that it also has a light barrier to further increase the shelf life of the final product.

The consumer prepares each meal by solely adding a warm or tempered liquid, upon which the dry product rehydrates and assumes the form, taste, consistency, and nutrient content of the fresh product prior to the drying, said drying constituting an essential feature of the method according to the present invention. Tests have shown that the rehydration takes place very rapidly and in practice often is complete within 30 seconds. The liquid is typically water but may also be other liquids alone or in combination with water, like milk, soy milk, breast-milk substitute etc

The drying comprises at least one drying step at a temperature below 0° C. This is essential to the product quality. The drying may comprise one or several drying steps. If a process comprising several drying steps are chosen it is convenient that each subsequent drying step has a temperature somewhat higher than the preceding drying step. It is feasible to use two steps which both are conducted at a temperature below 0° C. but where drying step 2 has a higher temperature than drying step 1. It is also feasible to use three drying steps where each step is conducted at a higher temperature than the temperature of the preceding drying step (T₁<T₂<T₃). It is particularly convenient for economical reasons that at least one drying step, particularly the last one, is conducted at a temperature higher than 0° C.

### Further Details of the Invention

According to preferred embodiments the invention is used to manufacture complete diner meals for infants, i.e. meals which typically include one component chosen among potato and vegetable and at least one component chosen among refined and unrefined products of meat and fish. The consistency of the product when prepared for eating has a significant impact on its applicability and it is preferred that the product upon rehydration has a non-liquid, paste-like consistency. The method can also be used for the manufacture of dry instant food comprising several components of fruit etc. for the manufacture of typical dessert courses.

In other preferred embodiments the method of the present invention is used to manufacture complete dinner courses for adults, typically for use in emergency situations as mentioned above and which mainly differ from the infant courses with respect to size and additions of taste substances like spice and/ or herbs. Thus the basic features of the various embodiments are independent of application area and user group.

The drying process, which constitutes a central element of the present invention, takes place at least partially at a temperature below the freezing point (of water) and ensures that the product does not shrink during this first stage of the drying process. It is an essential element to ensure that the final product is quickly rehydratable. It is particularly preferred to employ at least one further drying step at a temperature above the freezing point which makes the last part of the drying significantly quicker and less expensive than performing the entire drying process at a low temperature.

When a two step drying process is used first step of the drying process is conducted until the moisture content of the product is brought below about 50% and at a temperature which typically is lower than about −3° C. and preferably about −5° C. It is possible to run the entire drying process even at a significantly lower temperature but it is not convenient. It is also possible to allow the first step of the process to continue until a moisture content significantly lower than 50% is reached, but again this is not convenient in terms of the running the process economically. On the other hand, if the first drying step is reduced, i.e. to a moisture content significantly higher than about 50%, the product shows a reduced quality e.g. in terms of ability to rehydrate.

The second step of the drying process is typically conducted at a temperature in the range 10-30° C. and more typically about 20° C. It may be harmful to the product quality to increase the temperature further and there is not much to gain in form of reduced operating costs in doing so. The drying medium in the cold as well as the tempered part of the drier is a gaseous medium which does not show any adverse effects on the product. Air can be used as a drying medium but since presence of oxygen may lead to undesired oxidation of components of the product, it is ore preferred to use an inert gas like nitrogen or carbon dioxide.

It is feasible to divide the drying process into additional steps such as two or ore steps at a temperature below the freezing point and two or more steps at a temperature above the freezing point. It is however not much to gain economically or in product quality in doing so and it is therefore not a preferred embodiment of the invention. The drying process according to the present invention can be performed in a drier of the kind described in WO 89 08229 but also in other types of driers.

A particularly well suited way of drying foodstuff according to the present invention is drying in a so-called fluidized bed which requires that the product is divided into comparatively small and preferably even sized pieces which are placed in a drying chamber through which a gaseous drying medium is brought to flow from below and upwards between the pieces of the product to be dried. With an adapted volume flow rate of drying medium the drying medium will basically contact the surface of every single piece of the product. The rate need not be so high that the product pieces are suspended in the flow of drying medium; this is normally inconvenient and will lead to crumbling of the pieces. The division of the product into pieces can principally take place in two different manners, either by freezing the product as a block that is subsequently cut in a machine to desired size or the freezing is performed in discrete “pockets” on a tray until the product pieces no longer will stick to one another, thereby rendering the subsequent cutting superfluous.

In order to make the drying as efficient as possible it is convenient to use pieces of a limited size such as maximum 1 cm³. The size does not however influence on the product quality. With respect to what is most efficient in cutting or distribution I “pockets” for freezing, it is preferred to use pieces which are not less than about 0.02 cm³ (corresponds to a dice shape with a side of 2.7 mm).

It does not matter with respect to the technical feasibility of the method according to the present invention whether the raw materials to be used are refined or fresh. It is, however, convenient with respect to preservation of as much as possible of the nutrients that the raw materials are processed as little as possible before entering the preset process. Thus it is preferred that at least one of the components to be used is processed fro a fresh raw material. In this context we understand by a fresh raw material one that has not been frozen, boiled, cooked, marinated, diluted or the like. This is particularly important for the components chosen among vegetable, potatoes and fruit. With respect to raw materials of fish or meat it is usually convenient for reasons of bacterial control and general lasting ability to use raw material components which are refined. Accordingly in one preferred embodiment the method is conducted with at least one raw material component which already has been individually treated or refined.

It is possible to prepare each component alone and combine these immediately before the freezing. To develop the desired taste and flavour it is, however, often convenient and therefore preferred to combine two or more of the components in an earlier stage. Even though the separate raw material components to a certain extent requires different treatments and different treatment times this does not prevent that the last part of the treatment can take place after several and possibly all components have been combined, which constitute a preferred embodiment of the invention.

Dependant upon the raw materials used it may in some cases still be preferred that at least one raw material component is combined with the other immediately before starting the freezing. This could e. g. be the case if it is desired to have pieces of some size which would disintegrate if treated together with the other components.

The per se known preparation process or processes will normally include boiling in water, in milk or the like and can also include other types of treatment such as cooking or poaching in water or in a mixture of water and e.g. vinegar at a temperature lower than the boiling point of the mixture. It is thus often convenient and therefore preferred to use at least two different preparation processes which differ from another with respect to duration, application of heat etc.

During freezing it may be convenient to use a temperature which is significantly lower than the freezing point of water. A temperature as low as about −20° C. is commonly used but is no requirement of the present invention. With respect to the first part of the drying process it is vital that it takes place at a temperature lower than 0° C. It is preferred that it takes pace at a temperature lower than −3° C. and more preferred that it is conducted at a temperature lower than −5° C. There is no indication that product improvements are obtained by going significantly lower than −5° C. and the economy of the process is weakened if the temperature is reduced too much. A temperature about −10° C. can be chosen for this drying step as a fair compromise between economy and security against product deterioration caused by unintended temperature variations.

The last element of the process is the packing of the product in foil packages once drying is completed. It can be separate packages for each unit (portion) of the product or it can be packages comprising a plurality of product pockets so that 2, 4, 6 or more portions of the product are delivered together in a common package with individual seals for each portion. The foil typically comprises a moisture barrier and more preferred also a light barrier which contributes positively to the shelf life if the product in unbroken package. It is evident that the foil only has components which are allowed I contact with foodstuff.

### EXAMPLES

Tests were performed partly with especially prepared foodstuff (infant food) for the occasion and partly with a commercial type infant food on a glass jar. The product was frozen and cut into pieces of 5-8 mm or granulated to particles of 1-3 mm.

The drying was performed by two methods, one with constant temperature −10° C. (for comparison) and one with a two step drying according to the invention, with a first step at −10° C. and a second step at +20° C. Also for comparison some product was dried with a particular vacuum equipment that dries at a much lower temperature, typically −50 to −60° C.

For each drying cycle a drying plot was provided by removing small amounts of each sample at certain time intervals during the drying and measuring the moisture content in these by evaporation and weighing.

For each test a sample of about 1.4 kg of product was used.

Rehydration

Uptake of water in liquid form took place by transferring 0.2-0.6 grams of product to filter paper of type Schleider & Schuell, Ø 55 mm. The filter paper was beforehand humidified by the water which was sucked off in a Buchner funnel for 30 seconds. The product weight was measured before the filter paper ad the product was transferred to a filter holder (steel netting) and thereafter lowered into water of 40° C. After a defined time (30, 60, 180 sec.) the filter holder was removed from the water and transferred to a Buchner funnel in which surface water was sucked off for 2.5 minutes. The product weight was thereafter measured. Rehydration index was calculated from the following equation:

R=W_{f}/(Wₚ*T)

where W_{f} is weight of moist filter cake, Wₚ is weight of dry product, T is the dry weight part of the dried product.

A rehydration index of 4 thus implies a water content of 75% in the rehydrated product while a rehydration index of 5 implies a water content of 80% and so forth.

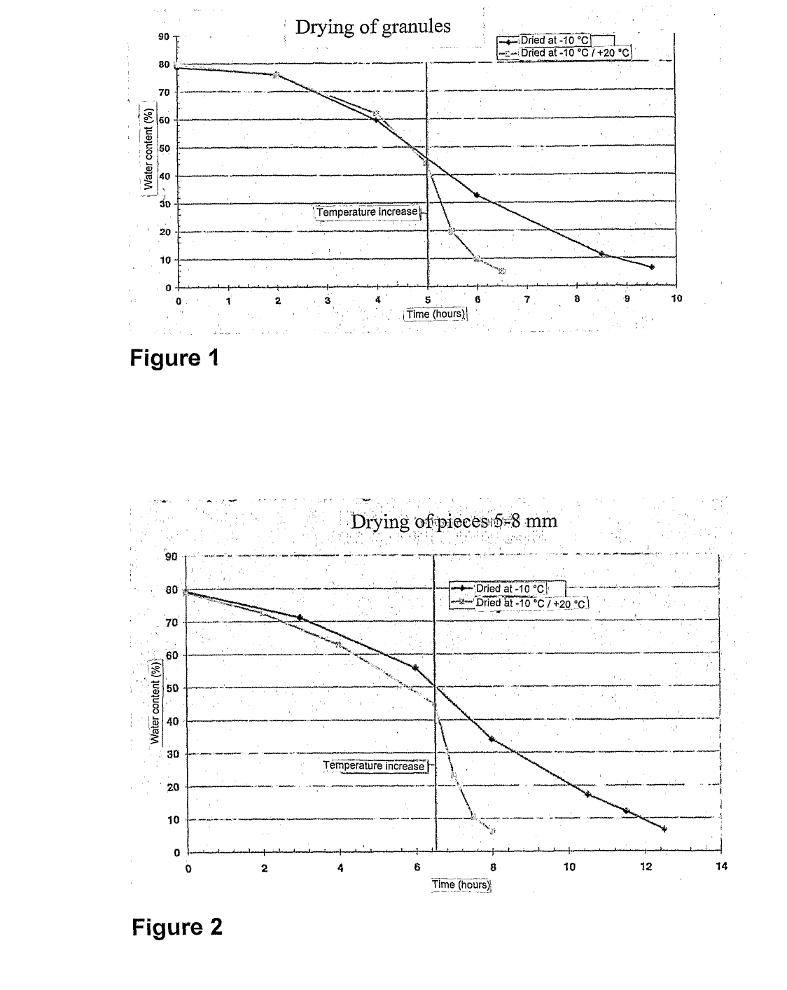

FIG. 1 is a plot of a drying graph for a drying process which is part of the method according to the present invention with a certain particle size, as well as a comparison graph.

FIG. 2 is a pot of a drying graph for a drying process which is part of the method according to the present invention, with a particle size different from the particle size of FIG. 1, a well as a comparison graph.

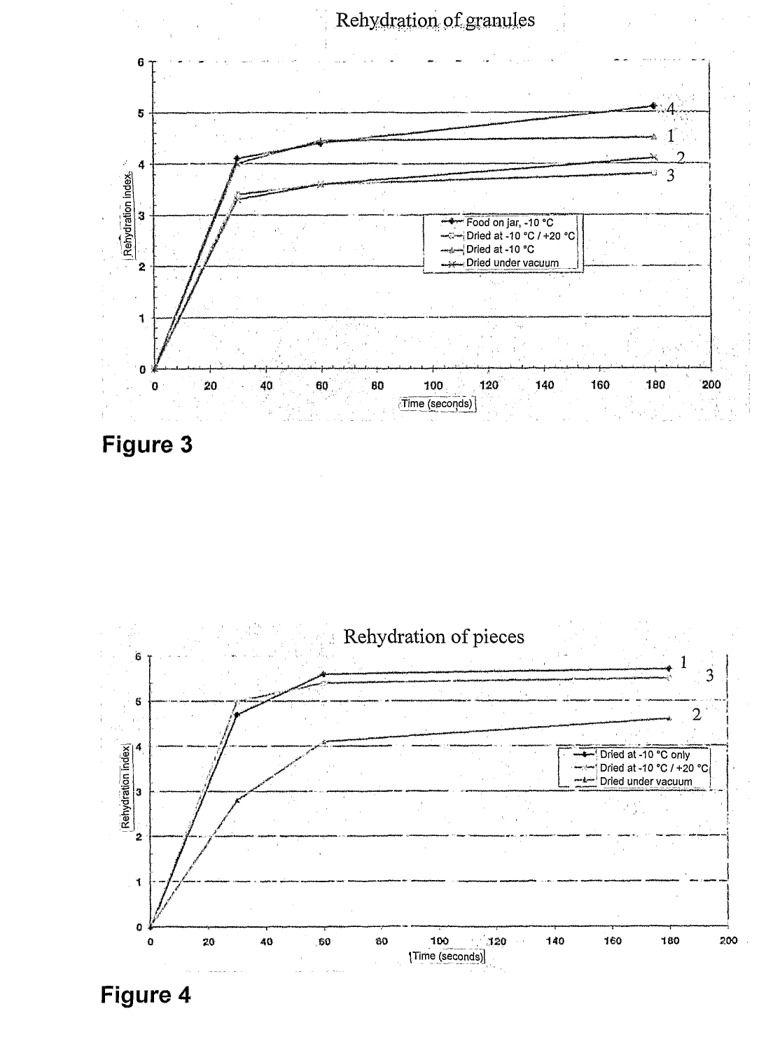

FIG. 3 is a plot of a rehydration graph for the product dried according to FIG. 1 as well as comparison graphs.

FIG. 4 is a plot of a rehydration graph for the product dried according to FIG. 2 as well as comparison graphs.

FIG. 1 shows a drying graph for the especially prepared infant food after freezing and granulation according to the present invention. The temperature was maintained at −10° C. until the moisture content has reached about 45%. Thereafter the temperature was raised to +20° C. and the drying was completed to a moisture content of about 7%. For comparison the same product was dried in a freeze drier at constant temperature −10° C. The figure shows that a moisture content of 7% was reached after about 6.5 hours with the method according to the invention while corresponding moisture content was reached after about 9.5 hours when drying at a constant temperature of −10° C.

FIG. 2 shows in principle the same as FIG. 1 but with a product having the form of somewhat larger pieces (dices 5-8 mm in one dimension corresponds to a volume per piece in the range between about 0.125 cm³ and 0.51 cm³⁾. In this case a final moisture content of about 6% was reached after 8 hours by the method according to the present invention and after 12.5 hours of drying at a temperature of −10° C.

FIG. 3 shows tests of rehydration of the product subject of FIG. 1 compared with drying of the especially prepared product dried at constant temperature −10° C. [1], the especially prepared product dried with the particular vacuum apparatus at very low temperature [2] and the especially prepared product dried according to the present invention at −10° C./+20° C. [3]. For comparison a commercial product was dried at −10° C. and rehydrated [4]. As shown by FIG. 3 all products allowed very quick rehydration with a rehydration index above 3 (67% water content) already within 30 seconds and a rehydration index in the range from about 5.2 to about 3.8 after 180 seconds.

FIG. 4 shows in principle the same as FIG. 3 but for product pieces of a size 5-8 mm. In this series the commercial product was not included. At this test the rehydration index increased even faster than for the smaller pieces and was close to 5 both for graph [1] (const. temp. −10° C.) and graph [3] (−10° C./+20° C. according to the invention) already after 30 seconds. For the larger pieces 5-8 mm there was generally little difference in rehydration index between the product samples dried at constant −10° C. and the samples dried I accordance with the present invention. In both cases the rehydration index was close to 5 (80% water content) already after 30 seconds and about 5.5 after 180 seconds, while the rehydration index for the product dried with the particular vacuum apparatus was significantly lower with values of about 2.8 and 4.7 after 30 seconds and 180 seconds respectively.

The tests showed that the granules as well as the larger pieces constitute products that are quickly rehydratable and in practice ready to serve in about 30 seconds. The best results were obtained with the larger pieces.

Water Activity

Measurements of water activity were made on each of the dried product samples since this is a good indication of shelf stability. The results are shown in the table below.

| | | Final water | |
|---|---|---|---|
| Product | Drying method | content | Water activity |
| Piece 5-8 mm | Constant −10° C. | 5.9% | 0.29 |
| Piece 5-8 mm | −10 C./+20° C. | 6.4% | 0.23 |
| | acc. to invention | | |
| Piece 5-8 mm | Vacuum part. app. | 1.5% | 0.08 |
| Granules 1-3 mm | Constant −10° C. | 5.3% | 0.31 |
| Granules 1-3 mm | −10° C./+20° C. | 6.4% | 0.32 |
| | ace. to invention | | |
| Granules 1-3 mm | Vacuum part. app. | 3.5% | 0.11 |
| Commercial product | Constant −10° C. | 6.7% | 0.36 |

All values were significantly below 0.6 which is regarded as a limit value for shelf stable products.

The present invention can be performed in a number of ways and with different types of equipment within the scope defined by the following claims.

1. Method for the preparation of dried instant food comprising two or more components, characterized in the combination of the following steps:
the individual components are prepared to a ready to serve meal by a per se known preparation process comprising adding a liquid and heating and mixing the components,
the resulting mixture is subjected to a drying process comprising
freezing the mixture,
drying the mixture to a moisture level lower than about 15%, the drying comprising at least one drying step at a temperature lower than 0° C.,
packing of the dried product in a foil package.

2. Method as claimed in claim 1, characterized in that (at least one of) the individual components is prepared from a fresh foodstuff component.

3. Method as claimed in claim 1, characterized in that (at least one of) the individual components is prepared from an individually refined foodstuff component.

4. Method as claimed in claim 1, characterized in that two or more of the components are combined before the per se known preparation process with liquid and heat addition is completed.

5. Method as claimed in claim 4, characterized in that all components are mixed before the per se preparation process is completed.

6. Method as claimed in claim 1, characterized in that at least one component is added to other components to form the resulting mixture after that the per se known preparation process is completed.

7. Method as claimed in claim 1, characterized in that the preparation process is comprised by at least two separate processes that are different from one another with respect to duration and the use of heat.

8. Method as claimed in claim 1, characterized in that at least one of the per se known preparation processes includes boiling.

9. Method as claimed in claim 1, characterized in that the drying comprises at least two steps, the first step being conducted at a temperature T₁ lower than 0° C. while a subsequent step is conducted at a temperature T₂ higher than T₁.

10. Method as claimed in claim 9, characterized in that the drying comprises at least one step at a temperature lower than 0° C. and at least one step at a temperature higher than 0° C.

11. Method as claimed in claim 10, characterized in that the drying at a temperature tower than 0° C. is conducted to a moisture level lower than about 50%.

12. Method as claimed in claim 1, characterized in that the mixture after freezing is cooled to a temperature no higher than −3° C., preferably no higher than 5° C. and that the first drying step is conducted at this temperature.

13. Method as claimed in claim 10, characterized in that the second drying step is conducted at a temperature in the range 10-30° C. and typically about 20° C.

14. Method as claimed in claim 1, characterized in that the mixture is frozen in form of pieces of a mainly homogenous size.

15. Method as claimed in claim 1, characterized in that the mixture after having been frozen is divided into pieces of mainly homogenous size.

16. Method as claimed in claim 14, characterized in that the pieces of mainly homogencus size are of a size in the range 0.02-1 cm.

17. Method as claimed in claim 9, characterized in that the first drying step is conducted in a fluidized bed drier.

18. Method as claimed in claim 1, characterized in that all drying steps are conducted in a fluidized bed drier.

19. Method as claimed in claim 1, characterized in that the moisture content after the last drying step is lower than 10%, preferably lower than 8%.

20. Method as claimed in claim 1, characterized in that the foil package is a multitayer foil package comprising at least one layer that constitute a moisture barrier.

21. Method as claimed in claim 1, characterized in that the foil package is a multilayer foil package comprising at least one layer that constitute a light barrier.

22. Dry instant food which is rehydratable in less than 3 minutes upon addition of hot water, characterized in that it is manufactured in accordance with claim 1.

23. Dry instant food as claimed in claim 22, characterized in that the food is infant food.

24. Dry instant food as claimed in claim 22, characterized in that it upon rehydration assumes a solid paste like mass.

25. Dry instant food as claimed in claim 23, characterized in that the infant food is multi portion packaged, more preferred packaged in a suitable light proof and water proof package with a heat barrier.

26. Dry instant food as claimed in claim 22, characterized in that it contains at least one component chosen among root vegetable and vegetable and at feast one component chosen among refined and unrefined products of meat and fish.
